(19) United States
(12) Patent Application Publication
(10) Pub. No.: US 2023/0036017 A1
(43) Pub. Date: Feb. 2, 2023

(54) LAST-LEVEL CACHE TOPOLOGY FOR VIRTUAL MACHINES

(71) Applicant: VMware, Inc., Palo Alto, CA (US)

(72) Inventors: Xunjia LU, Los Altos, CA (US); Yifan HAO, San Francisco, CA (US); Sam SCALISE, San Jose, CA (US)

(21) Appl. No.: 17/382,070

(22) Filed: Jul. 21, 2021

(51) Int. Cl. G06F 9/455; G06F 12/0815

(52) U.S. Cl. CPC G06F 9/45558; G06F 12/0815; G06F 2009/45583; G06F 2009/45591; G06F 2009/4557

(57) ABSTRACT

An example method of determining size of virtual last-level cache (LLC) exposed to a virtual machine (VM) supported by a hypervisor executing on a host computer includes: obtaining, by the hypervisor, a host topology of the host computer, the host topology including a number of LLCs in a central processing unit (CPU) of the host computer and a host LLC size being a size of each of the LLCs in the CPU; obtaining, by the hypervisor, a virtual socket size for a virtual socket presented to the VM by the hypervisor and a virtual non-uniform memory access (NUMA) node size presented to the VM by the hypervisor; determining, by the hypervisor, a virtual LLC size for the VM based on the host topology, the virtual socket size, the virtual NUMA node size, and a plurality of constraints; and presenting, to the VM, the virtual LLC size in processor feature discovery information.

### BACKGROUND

Computer virtualization is a technique that involves encapsulating a physical computing machine platform into virtual machine(s) executing under control of virtualization software on a hardware computing platform or “host.” A virtual machine (VM) provides virtual hardware abstractions for processor, memory, storage, and the like to a guest operating system. The virtualization software, also referred to as a “hypervisor,” incudes one or more virtual machine monitors (VMMs) to provide execution environment(s) for the virtual machine(s). As physical hosts have grown larger, with greater processor core counts and terabyte memory sizes, virtualization has become key to the economic utilization of available hardware.

Traditional processors have one last-level cache (LLC) per socket. For example, an x86 processor can be on one integrated circuit (IC) (i.e., one socket) and have one LLC (e.g., one L3 cache shared among all cores). Recently, some processors can have multiple core groups per socket, where each core group has its own LLC. Examples of such a processor are the EPYC series of processors available from Advanced Micro Devices, Inc. In this architecture, cross-LLC reference is much slower than intra-LLC reference even if the LLCs are within the same non-uniform memory access (NUMA) domain. Some operating systems are optimized for such a platform, ensuring optimized placement of threads on the cores to avoid slow cross-LLC

### REFERENCES

A hypervisor presents virtual hardware to VMs, including a virtual LLC. A hypervisor can set the size of a virtual LLC (in terms of cores used as virtual CPUs (vCPUs)) to match the size of the virtual socket. For example, for a VM with twelve vCPUs, the hypervisor can assign all twelve vCPUs into one single virtual socket. The hypervisor can also choose to set the size of virtual LLC to be equal to virtual socket. However, if the processor has the architecture described above with multiple LLCs (e.g., four physical cores per physical LLC), the scheduler in a guest operating system of a VM would not be able to recognize the fact that those twelve vCPUs are placed on different physical LLCs within the same socket. This can lead the in-guest scheduler to make suboptimal decisions when scheduling guest operating system threads on the vCPUs (e.g., scheduling threads in a manner that results in cross-LLC references unbeknownst to the guest operating system).

### SUMMARY

One or more embodiments relate to a method of determining size of virtual last-level cache (LLC) exposed to a virtual machine (VM) supported by a hypervisor executing on a host computer comprising: obtaining, by the hypervisor, a host topology of the host computer, the host topology including a number of LLCs in a central processing unit (CPU) of the host computer and a host LLC size being a size of each of the LLCs in the CPU; obtaining, by the hypervisor, a virtual socket size for a virtual socket presented to the VM by the hypervisor and a virtual non-uniform memory access (NUMA) node size presented to the VM by the hypervisor; determining, by the hypervisor, a virtual LLC size for the VM based on the host topology, the virtual socket size, the virtual NUMA node size, and a plurality of constraints; and presenting, by the hypervisor to the VM, the virtual LLC size in processor feature discovery information.

Further embodiments include a non-transitory computer-readable storage medium comprising instructions that cause a computer system to carry out the above method, as well as a computer system configured to carry out the above method. Though certain aspects are described with respect to VMs, they may be similarly applicable to other suitable physical and/or virtual computing instances.

### BRIEF DESCRIPTION OF THE DRAWINGS

FIG. 1 is a block diagram depicting a virtualized computing system according to an embodiment.

FIG. 2 is a block diagram depicting structure of a central processing unit (CPU) according to embodiments.

FIG. 3 is a block diagram depicting virtual topology on top of physical hardware according to embodiments.

FIG. 4 is a flow diagram depicting a method of determining a size of each virtual last-level cache (LLC) presented to a virtual machine (VM) by a hypervisor according to embodiments.

FIG. 5 is a flow diagram depicting a method of providing virtual LLC size to a VM according to embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Last-level cache topology for virtual machines is described. As noted above, hypervisors can determine the size of virtual last-level cache (vLLC) presented to a virtual machine (VM) to be the size of the virtual socket. That is, the vLLC presented to the VM is the same number of central processing unit (CPU) cores as in the virtual socket presented to the VM. As described above, this can lead the scheduler in the guest operating system (OS) to make suboptimal decisions when scheduling threads on the virtual CPUs (vCPUs). Techniques described herein provide a more optimal approach to determining vLLC size for a VM. In embodiments, the hypervisor obtains the host topology, which includes a number of LLCs in the CPU and a size of those LLCs (“host LLC size”). The hypervisor further Obtains a virtual socket size for a virtual socket presented to the VM and a virtual non-uniform memory access (NUMA) node size presented to the VM. The hypervisor then determines a vLLC size for the VM based on the host topology, the virtual socket size, the virtual NUMA node size; and a plurality of constraints. The vLLC size is presented to the VM in processor feature discovery information (e.g., a virtual CPU identifier (CPUID)). Example constraints include that a number of virtual LLCs be less than the number of LLCs in the CPU, that the virtual NUMA node size be a multiple of the vLLC size, that the virtual socket size be a multiple of the vLLC size, and that the vLLC size be closest to, but not larger than, the host LLC size. These and further aspects of the techniques are described below with respect to the drawings.

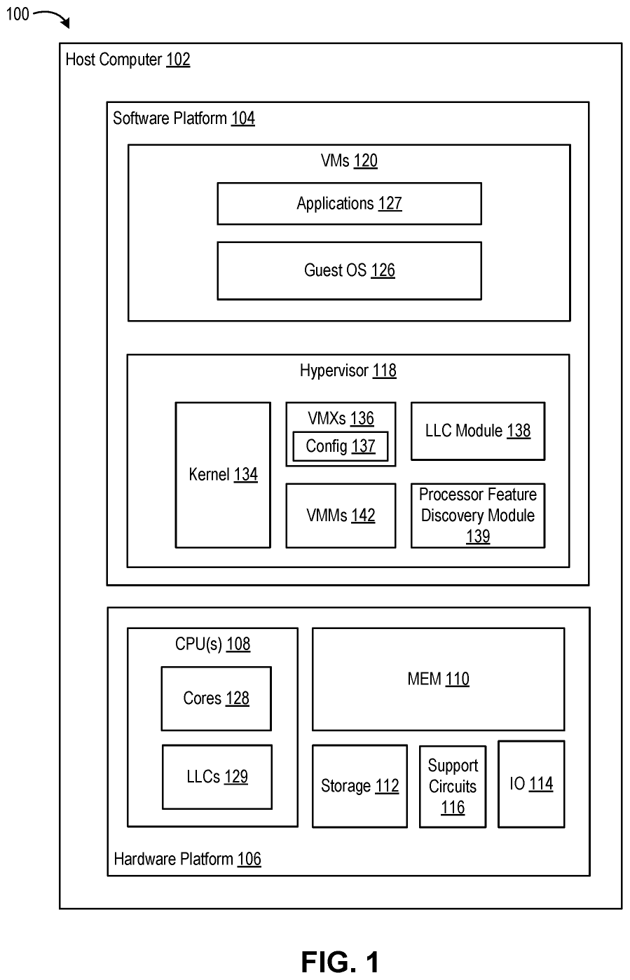

FIG. 1 is a block diagram depicting a virtualized computing system 100 according to an embodiment. Virtualized computing system 100 includes a host computer 102 having a software platform 104 executing on a hardware platform 106. Hardware platform 106 may include various components of a computing device, such as one or more central processing unit (CPUs) 108, system memory (MEM) 110, a storage system (storage) 112, input/output devices (IO) 114, and various support circuits 116. Each CPU 108 is configured to execute instructions, for example, executable instructions that perform one or more operations described herein and may be stored in system memory 110 and storage system 112. System memory 110 is a device allowing information, such as executable instructions, virtual disks, configurations, and other data, to be stored and retrieved. System memory 110 may include, for example, one or more random access memory (RAM) modules. Storage system 112 includes local storage devices (e.g., one or more hard disks, flash memory modules, solid state disks, and optical disks) and/or a storage interface that enables host computer 102 to communicate with one or more network data storage systems. Examples of a storage interface are a host bus adapter (HBA) that couples host computer 102 to one or more storage arrays, such as a storage area network (SAN) or a network-attached storage (NAS), as well as other network data storage systems. Storage 112 in multiple hosts 120 can be aggregated and provisioned as part of shared storage accessible through a physical network (not shown). Input/output devices 114 include various interfaces known in the art, such as one or more network interfaces. Support circuits 116 include various cache, power supplies, clock circuits, data registers, and the like.

Each CPU 108 includes cores 128 and last-level caches (LLCs) 129. Each core 128 is a microprocessor configured to execute instructions. Each LLC 129 comprises RAM associated with a group of cores 128 and is the last level of cache in a multi-level cache hierarchy of CPU 108 (lower cache levels not shown). Each CPU 108 is a physical integrated circuit (IC) disposed on a printed circuit board (PCB) and is referred to herein as a “socket.” For example, hardware platform can include a topology having two sockets, where each socket supports a separate CPU 108.

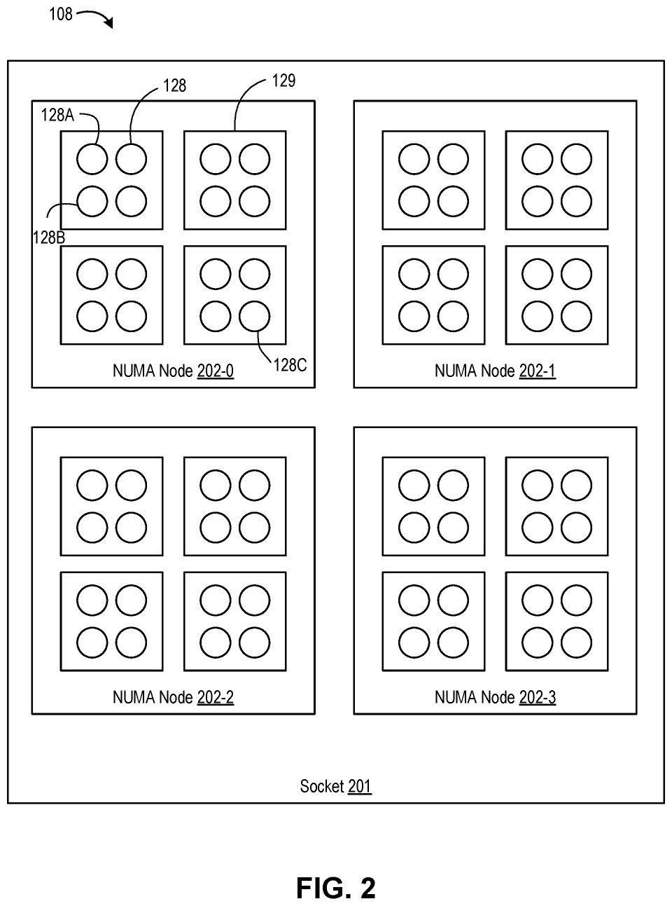

FIG. 2 is a block diagram depicting structure of a CPU 108 according to embodiments. CPU 108 is disposed in a socket 201 and includes a plurality of cores 128 (e.g., 64 cores are shown). In embodiments, cores 128 are organized into different non-uniform memory access (NUMA) nodes 202 (e.g., four NUMA nodes 202-0 through 202-3 are shown). Within each NUMA node 202, cores 128 are further grouped based on LLC 129. In the example shown, each NUMA node 202 includes four LLCs 129, each associated with four cores 128. Each set of cores 128 and corresponding LLC 129 is referred to as a core group. In general, CPU 108 includes a plurality of core groups organized into one or more NUMA nodes 202. As noted above, such a structure for CPU 108 exhibits non-uniform cache access (NUCA) in that intra-LLC references (e.g., between a core 128A and a core 128B) have less latency than cross-LLC references (e.g., between core 128A/B and a core 128C in another core group). Thus, an operating system aware of the NUCA architecture will schedule threads that share data within the same core group to avoid high-latency cross-LLC references.

Returning to FIG. 1, software platform 104 includes a virtualization layer that abstracts processor, memory, storage, and networking resources of hardware platform 106 into one or more virtual machines (“VMs”) that run concurrently on host computer 102. The VMs run on top of the virtualization layer, referred to herein as a hypervisor, which enables sharing of the hardware resources by the VMs. In the example shown, software platform 104 includes a hypervisor 118 that supports VMs 120. One example of hypervisor 118 that may be used in an embodiment described herein is a VMware ESXi™ hypervisor provided as part of the VMware vSphere® solution made commercially available from VMware, Inc. of Palo Alto, Calif. (although it should be recognized that any other virtualization technologies, including Xen® and Microsoft Hyper-V® virtualization technologies may be utilized consistent with the teachings herein). Hypervisor 118 includes a kernel 134, virtual machine executable (VMX) processes 136, virtual machine monitors (VMMs) 142, LLC module 138, and processor feature discovery module 139.

Each VM 120 includes guest software that runs on the virtualized resources supported by hardware platform 106. In the example shown, the guest software of VM 120 includes a guest OS 126 and applications 127. Guest OS 126 can be any commodity operating system known in the art (e.g., Linux®, Windows®, etc.). Applications 127 can software that are part of guest OS 126 or otherwise managed by guest OS 126. Guest OS 126 can be optimized for thread placement on processors with multiple core groups.

Kernel 134 provides operating system functionality (e.g., process creation and control, file system, process threads, etc.), as well as CPU scheduling and memory scheduling across VMs 120, VMMs 142, VMX processes 136, LLC module 138, and processor feature discovery module 139 (among other modules not shown). VMMs 142 implement the virtual system support to coordinate operations between hypervisor 118 and VMs 120. Each VMM 142 manages a corresponding virtual hardware platform that includes emulated hardware, such as virtual CPUs (vCPUs) and guest physical memory (also referred to as VM memory). Each virtual hardware platform supports the installation of guest software in a corresponding VM 120. Each VMM 142 can include a separate process for each vCPU assigned to a VM 120, which is responsible for virtualizing guest OS instructions and managing memory. Each VMX process 136 is responsible for handling some input/output (TO) devices for a VM 120, as well as for communicating with user interfaces, snapshot managers, remote consoles, and other external software. Each VMX process 136 has a configuration (config 137), which can include various settings for a respective VM 120.

LLC module 138 is a process configured to determine size of each virtual LLC (vLLC) exposed to a VM 120. Processor feature discovery module 139 is a process configured to generate and expose processor feature discovery information to each VM 120. Processor feature discovery information is a mechanism for presenting the various features of a CPU to an operating system. For example, an x86 processor includes a CPU identifier (CPUID) that, when read by an operating system, describes the features of the CPU. In embodiments, hypervisor 118 can present a virtual CPUID (vCPUID) to each VM 120 as the processor feature discovery information. Other types of processors can include different mechanisms for presenting processor feature discovery information. For example, an ARM® processor presents processor feature discovery information using processor feature registers (PFRs). A RISC-V processor presents processor feature discovery information using control and status registers (CSRs). For purposes of clarity by example, embodiments described below assume an x86 type CPU and the processor feature discovery information is described as CPUID and virtual CPUID.

Processor feature discovery module 139 is configured to communicate with LLC module 138 to obtain a size for the vLLC(s). In embodiments, processor feature discovery module 139 adds vLLC size to the vCPUID in a “topology leaf,” which is any section of a vCPUID that includes CPU topology information. When a VM 120 is powered on, the VM reads the vCPUID presented by hypervisor 118. Since vLLC size is a static value that does not vary between different vCPUs, vLLC size is initialized once during VM power on by reading its value from the topology leaf of the vCPUID. For example, for an AMD® processor, processor feature discovery module 139 can enable the 8000_001D extended topology leaf of vCPUID to mimic how a physical processor exposes physical LLC size. When guest OS 126 executes a CPUID instruction, the vCPUID is written into the designated registers of a vCPU, including the vLLC size (e.g., in register EAX[25:14] of an AMD processor). Processor feature discovery module 139 can set the vLLC size for other types of processors that support multiple core groups in a similar fashion depending on their processor feature discovery mechanisms.

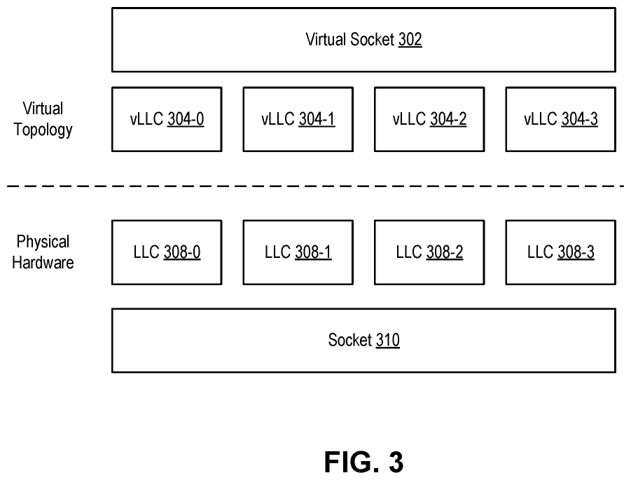

FIG. 3 is a block diagram depicting virtual topology on top of physical hardware according to embodiments. In the example, the physical hardware includes a socket 310 having four core groups, which include four LLCs 308-0 through 308-3 (cores are omitted for clarity). Hypervisor 118 presents a virtual topology to a VM 120, which includes a virtual socket 302 and four vLLCs 304-0 through 304-3. Thus, rather than a single vLLC per virtual socket 302, hypervisor 118 presents a determined number of vLLCs 304. Hypervisor 118 presents a size of virtual socket 302 and each vLLC 304 to VM 120 in the vCPUID, which can be read by the guest OS. While this example shows four physical LLCs 308 and four vLLCs 304, a socket 310 can include a different number of physical LLCs 308 and hypervisor 118 can present a different number of vLLCs 304 in the virtual topology. An embodiment of a process for determining the vLLC size (and hence number of vLLCs) is described below.

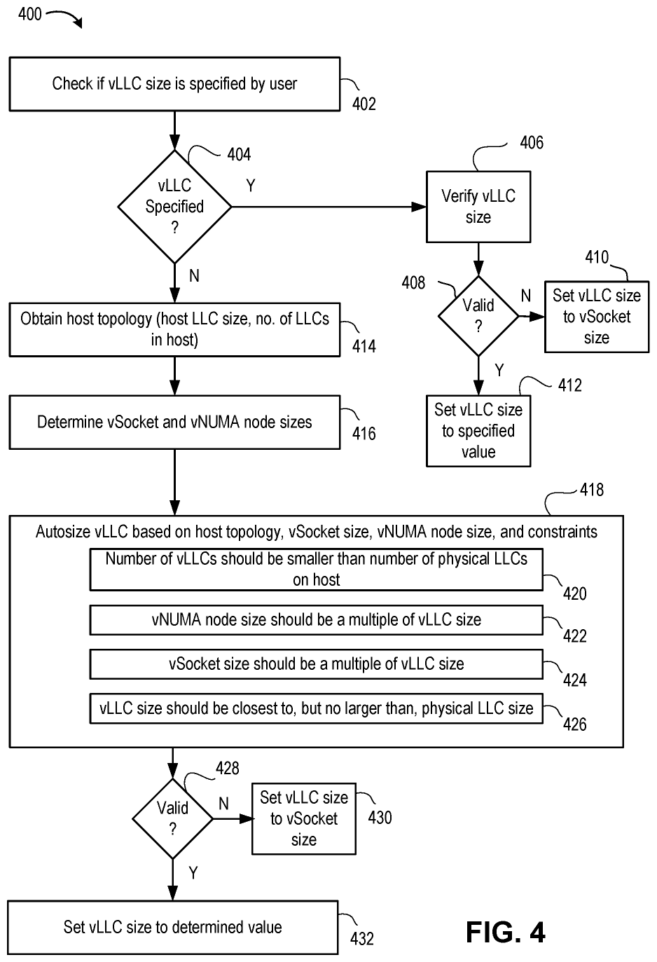

FIG. 4 is a flow diagram depicting a method 400 of determining a size of each virtual LLC presented to a VM by a hypervisor according to embodiments. Method 400 is performed by LLC module 138. Method 400 begins at step 402, where LLC module 138 checks if vLLC size has been specified by the user. In embodiments, a user can set vLLC size for a given VM 120 in config 137. For example, a user can set a parameter in config 137 to manually specify the vLLC size for a VM 120. The size of vLLC is specified in terms of cores or equivalently vCPUs. At step 404, LLC module 138 determines if the user has specified vLLC size. If so, method 400 proceeds to step 406.

At step 406, LLC module 138 verifies the user-specified vLLC size. In embodiments, there are constraints on a user-specified vLLC size. The vLLC cannot be cross vSocket, meaning that vLLC size cannot be greater than vSocket size (e.g., a parameter in config 137). In addition, vSocket size needs to be a multiple of user-specified vLLC size, which implies that all vLLCs should have the same size. VM 120 cannot see vLLCs with different sizes. At step 408, LLC module 138 determines if the user-specified vLLC size is valid based on the constraints. If not, method 400 proceeds to step 410, where LLC module 138 sets vLLC size to be the vSocket size. Otherwise, method 400 proceeds to step 412, where LLC module 138 sets vLLC size to be the user-specified value.

If at step 404 the user has not specified a vLLC size for the VM, method 400 proceeds from step 404 to step 414 for automatic determination of vLLC size. At step 414, LLC module 138 obtains host topology information, including host LLC size and number of LLCs in host. For example, given CPU 108 shown in FIG. 2, host LLC size is four cores and the number of LLCs in the host is 16. LLC module 138 can obtain this information from kernel 134, which can obtain this information by executing a CPUID instruction upon boot of hypervisor 118. Alternatively, LLC module 138 can execute the CPUID instruction itself.

At step 416, LLC module 138 determines vSocket and vNUMA node sizes. In embodiments, vSocket and vNUMA sizes can be specified by the user in config 137. That is, the user configures the number of virtual sockets, the number of vCPUs (cores) per virtual socket, and the number of vCPUs (cores) per NUMA node. The vSocket and vNUMA sizes can be set automatically by other mechanisms, which are beyond the scope of the present disclosure. In general, prior to execution of method 400 for determining vLLC size, vSocket and vNUMA sizes have been previous determined and/or set.

At step 418, LLC module 138 automatically determines a vLLC size based on host topology (host LLC size, number of physical LLCs), vSocket size, vNUMA size, and a plurality of constraints. In embodiments, constraints are specified in 420, 422, 424, and 426. As shown in step 420, vLLC size should be smaller than the number of physical LLCs on the host. At step 422, the vNUMA node size should be a multiple of vLLC size. This implies that vNUMA node size should be equal to or greater than vLLC size. At step 424, vSocket size should be a multiple of vLLC size. This implies that vSocket size should be equal to or greater than vLLC size. At step 426, vLLC size should be closest to, but not greater than, physical LLC size. This implies that if there are multiple values that satisfy the constraints in 420-424, then LLC module 138 selects the largest size that is smaller than the size of the physical LLC. This also implies that the number of vLLCs should be minimal.

At step 428, LLC module 138 determines if a valid vLLC size can be set based on the constraints and the input values of host LLC size, number of host LLCs, vSocket size, and vNUMA node size. If not, method 400 proceeds to step 430, where LLC module 138 sets vLLC size to the vSocket size. Otherwise, method 400 proceeds to step 432, where LLC module 138 sets vLLC size to the value automatically determined in step 418.

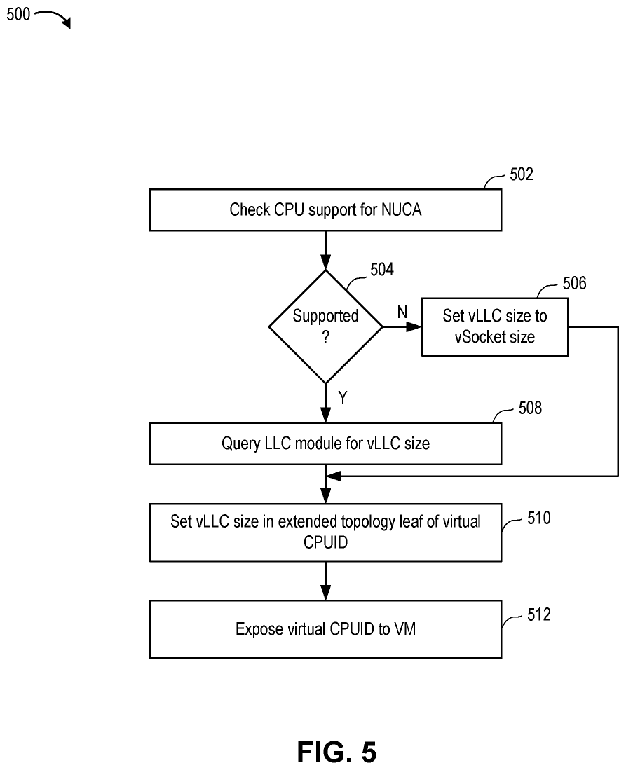

FIG. 5 is a flow diagram depicting a method 500 of providing virtual LLC size to a VM according to embodiments. Method 500 is performed by processor feature discovery module 139. Method 500 begins at step 502, where processor feature discovery module 139 checks CPU support for NUCA. As discussed above, CPUs that support NUCA include multiple core groups, each having a set of cores and an associated LLC. At step 504, processor feature discovery module 139 determines if NUCA is supported by CPU(s) 108. If not, method 500 proceeds to step 506, where vLLC size is set to vSocket size. Otherwise, method 500 proceeds to step 508. Processor feature discovery module 139 can determine if NUCA is supported by querying kernel 134, which maintains information obtained from execution of the CPUID instruction that specifies host processor topology. Alternatively, processor feature discovery module 139 can execute the CPUID instruction itself. Processor feature discovery module 139 can execute other instructions depending on the mechanism for obtaining processor feature discovery information (e.g., instructions for reading from certain registers). From step 506, method 500 proceeds to step 510.

At step 508, processor feature discovery module 139 queries LLC module 138 for vLLC size. At step 510, processor feature discovery module 139 sets vLLC size in a topology leaf of a vCPUID. At step 512, processor feature discovery module 139 exposes the vCPUID to the VM. Guest OS 126 can execute a CPUID instruction to read vCPUID and obtain vLLC size among other topology values (e.g., vSocket size).

The following table shows some possible auto-generated vLLC sizes assuming the host LLC size is 4 cores per LLC and 16 host LLCs such as shown in FIG. 2.

TABLE 1

| vSocket | vNUMA | vLLC |
|---|---|---|
| 1 | 1 | 1 |
| 2 | 2 | 2 |
| 3 | 3 | 3 |
| 4 | 4 | 4 |
| 6 | 6 | 3* |
| 10 | 5 | 10** |
| 11 | 10 | 11*** |
| 12 | 4 | 4 |

For the superscript “*” in Table 1, when vSocket and vNUMA node sizes are six, LLC module 138 generates a vLLC size of three because three is a divisor of vSocket and vNUMA node sizes that is closest to but no larger than the host limit of four. For the superscript “*” in Table 1, when there is no value satisfying host LLC size, vSocket size is used as vLLC size as noted above. For the superscript “***” in Table 1, when vSocket and vNUMA node sizes are not consistent with each other, this is due to the user manually setting an inconsistent value. In this case, vLLC size falls back to vSocket.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of determining size of virtual last-level cache (LLC) exposed to a virtual machine (VM) supported by a hypervisor executing on a host computer, the method comprising:
obtaining, by the hypervisor, a host topology of the host computer, the host topology including a number of LLCs in a central processing unit (CPU) of the host computer and a host LLC size being a common size of the LLCs in the CPU;
obtaining, by the hypervisor, a virtual socket size for a virtual socket presented to the VM by the hypervisor and a virtual non-uniform memory access (NUMA) node size presented to the VM by the hypervisor;
determining, by the hypervisor, a virtual LLC size for the VM based on the host topology, the virtual socket size, the virtual NUMA node size, and a plurality of constraints; and
presenting, by the hypervisor to the VM, the virtual LLC size in processor feature discovery information.

2. The method of claim 1, wherein the plurality of constraints include:
a first constraint that a number of virtual LLCs be less than the number of LLCs in the CPU;
a second constraint that the virtual NUMA node size be a multiple of the virtual LLC size; and
a third constraint that the virtual socket size be a multiple of the virtual LLC size.

3. The method of claim 2, wherein the plurality of constraints include:
a fourth constraint that the virtual LLC size be closest to, but not larger than, the host LLC size.

4. The method of claim 1, wherein the virtual LLC size is less than the number of LLCs, less than the virtual NUMA node size, less than the virtual socket size, and closest to, but not larger than, the host LLC size.

5. The method of claim 1, wherein, in response to failure to satisfy at least one of the plurality of constraints, the virtual LLC size is equal to the virtual socket size.

6. The method of claim 1, wherein the processor feature discovery information comprises a virtual CPU identifier (CPUID).

7. The method of claim 1, wherein the CPU of the host computer supports non-uniform cache access (NUCA).

8. A non-transitory computer readable medium having instructions stored thereon that when executed by a processor cause the processor to perform a method of determining size of virtual last-level cache (LLC) exposed to a virtual machine (VM) supported by a hypervisor executing on a host computer, the method comprising:
obtaining, by the hypervisor, a host topology of the host computer, the host topology including a number of LLCs in a central processing unit (CPU) of the host computer and a host LLC size being a common size of the LLCs in the CPU;
obtaining, by the hypervisor, a virtual socket size for a virtual socket presented to the VM by the hypervisor and a virtual non-uniform memory access (NUMA) node size presented to the VM by the hypervisor;
determining, by the hypervisor, a virtual LLC size for the VM based on the host topology, the virtual socket size, the virtual NUMA node size, and a plurality of constraints; and
presenting, by the hypervisor to the VM, the virtual LLC size in processor feature discovery information.

9. The non-transitory computer readable medium of claim 8, wherein the plurality of constraints include:
a first constraint that a number of virtual LLCs be less than the number of LLCs in the CPU;
a second constraint that the virtual NUMA node size be a multiple of the virtual LLC size; and
a third constraint that the virtual socket size be a multiple of the virtual LLC size.

10. The non-transitory computer readable medium of claim 9, wherein the plurality of constraints include:
a fourth constraint that the virtual LLC size be closest to, but not larger than, the host LLC size.

11. The non-transitory computer readable medium of claim 8, wherein the virtual LLC size is less than the number of LLCs, less than the virtual NUMA node size, less than the virtual socket size, and closest to, but not larger than, the host LLC size.

12. The non-transitory computer readable medium of claim 8, wherein, in response to failure to satisfy at least one of the plurality of constraints, the virtual LLC size is equal to the virtual socket size.

13. The non-transitory computer readable medium of claim 8, wherein the processor feature discovery information comprises a virtual CPU identifier (CPUID).

14. The non-transitory computer readable medium of claim 8, wherein the CPU of the host computer supports non-uniform cache access (NUCA).

15. A virtualized computing system, comprising:
a hardware platform comprising a central processing unit (CPU) having a plurality of core groups;
a software platform executing on the hardware platform and including a hypervisor supporting a virtual machine (VM), the hypervisor operable to:
obtain a host topology of the hardware platform, the host topology including a number of last-level caches (LLCs) in the CPU and a host LLC size being a common size of the LLCs in the CPU;
obtain a virtual socket size for a virtual socket presented to the VM by the hypervisor and a virtual non-uniform memory access (NUMA) node size presented to the VM by the hypervisor;
determine a virtual LLC size for the VM based on the host topology, the virtual socket size, the virtual NUMA node size, and a plurality of constraints; and
present, to the VM, the virtual LLC size in processor feature discovery information.

16. The virtualized computing system of claim 15, wherein the plurality of constraints include:
a first constraint that a number of virtual LLCs be less than the number of LLCs in the CPU;
a second constraint that the virtual NUMA node size be a multiple of the virtual LLC size; and
a third constraint that the virtual socket size be a multiple of the virtual LLC size.

17. The virtualized computing system of claim 16, wherein the plurality of constraints include:
a fourth constraint that the virtual LLC size be closest to, but not larger than, the host LLC size.

18. The virtualized computing system of claim 15, wherein the virtual LLC size is less than the number of LLCs, less than the virtual NUMA node size, less than the virtual socket size, and closest to, but not larger than, the host LLC size.

19. The virtualized computing system of claim 15, wherein, in response to failure to satisfy at least one of the plurality of constraints, the virtual LLC size is equal to the virtual socket size.

20. The virtualized computing system of claim 15, wherein the processor feature discovery information comprises a virtual CPU identifier (CPUID).
